(19) United States
(12) Patent Application Publication
(10) Pub. No.: US 2008/0034591 A1
(43) Pub. Date: Feb. 14, 2008

(54) Shaver with swivel head

(76) Inventor: Kam Fai Fung, Tuen Mun (HK)

Correspondence Address: Lawrence Cruz;Conair Corporation, One Cummings Point Road, STAMFORD, CT, 06902, US

(21) Appl. No.: 11/500,844

(22) Filed: Aug. 8, 2006

(51) Int. Cl. B26B 19/02; B26B 21/52

(52) U.S. Cl. 30/43.92; 30/529

(57) ABSTRACT

A shaving device includes an assembly to better maintain the cutting blades in contact with the skin during shaving. A swivel ball joint is preferably located between the shaver head and the housing and enables the head of the shaver to move in any direction from a longitudinal axis through the shaving device. A positioning spring connected to the ball joint and the housing is biased toward the center axis of the shaver and provides a swivel action that causes the shaver head to return back to its center position after adjustment of the head's angle. A motion transfer spring transfers the motor action to the upper shaving mechanism at any angle or direction that the shaver head may be in at any time. As the shaver head changes angles to match the contour of the user's body, the motion transfer spring flexes to follow the angles of the shaver head. This transfers the motion of the motor to the eccentric cam, which helps to control the motion of the trimmers. In order to prevent water from entering into the electrical parts of the shaving device, a water-resistant cap and a water-resistant O-ring can be utilized.

### CROSS-REFERENCE TO RELATED APPLICATIONS

None.

### BACKGROUND OF THE INVENTION

1. Field of the Invention

The present invention relates to a shaving device and, more particularly, to a shaver with a swivel head, especially of the type with a ball joint supporting the head to enable the head to pivot in any direction.

2. Description of Related Art

It is known in the art to use an electric shaver to remove unwanted body or facial hair. Various types of conventional electric shavers are structured to allow movement of the head in relation to the grip as a means of better maintaining the cutting blades in contact with the skin during shaving.

While various known shavers exist, there is a need for a shaver that uses a ball joint supporting the head to enable the head to pivot in a smoother and more easily controlled way.

### OBJECT AND SUMMARY OF THE INVENTION

It is an object of the present invention to overcome the shortcomings of the prior art mentioned above. These and other objects are achieved by the present invention described herein.

The present invention achieves at least the above-listed objectives by utilizing a shaver that includes a housing and a shaver head. The housing preferably has a switch to turn the power on or off and an indication light to indicate whether the power is on or off. The head can have one or more shaving foils and one or more trimmers to trim hair, as well as a trimming guide to control the length at which the hair is trimmed.

The shaving device includes a swivel ball joint that is preferably located between the shaver head and the housing. This swivel ball joint enables the head of the shaver to move in any direction from a longitudinal axis through the shaving device. This enables the head and accompanying trimmers to move to the contour of the body part being shaved. A positioning spring is connected to the ball joint and the housing. The positioning spring is biased toward the center axis of the shaver and provides a swivel action that causes the shaver head to return back to its center position after adjustment of the head's angle.

A motion transfer mechanism transfers the motor action to the upper shaving mechanism at any angle or direction that the shaver head may be in at any time. This is accomplished through the use of a motion transfer spring that connects the motor to the eccentric cam. As the shaver head changes angles to match the contour of the user's body, the motion transfer spring flexes to follow the angles of the shaver head. This transfers the motion of the motor to the eccentric cam, which helps to control the motion of the trimmers. In order to prevent water from entering into the electrical parts of the shaving device, a water-resistant cap and a water-resistant O-ring can be utilized.

### BRIEF DESCRIPTION OF THE DRAWINGS

The present invention is more fully understood by reference to the following detailed description of an illustrative embodiment with the drawings identified below.

FIG. 1 is a perspective view of a preferred embodiment of the shaving device in accordance with the present invention.

FIG. 2A is a perspective view of a preferred embodiment of the shaving device and charger in accordance with the present invention.

FIG. 2B is a perspective view of a preferred embodiment of the shaving device and charger in accordance with the present invention.

FIG. 3 is an exploded view of the preferred embodiment of the shaving device in accordance with the present invention.

FIG. 4A is a perspective view in accordance with an illustrative embodiment of the shaving device of FIG. 1.

FIG. 4B is a perspective view in accordance with an illustrative embodiment of the shaving device of FIG. 1.

FIG. 5 is a perspective view of the shaver head in accordance with an illustrative embodiment of the shaving device of FIG. 1.

FIG. 6 is a front view of the shaver head in accordance with an illustrative embodiment of shaving device of FIG. 1.

FIG. 7A is a partial perspective view showing the motor, spring and cam in accordance with an illustrative embodiment of the shaving device shown in FIG. 1.

FIG. 7B is a side cross-sectional view showing the motor, spring and cam in accordance with an illustrative embodiment of the shaving device shown in FIG. 1.

FIG. 7C is a front view of the motor, spring and cam in accordance with an illustrative embodiment of the shaving device shown in FIG. 1.

FIG. 8 is an exploded view showing various components of the shaving device shown in FIG. 1.

FIG. 9 is a partial perspective cross-sectional view showing various components of the shaving device shown in FIG. 1.

### DETAILED DESCRIPTION OF THE INVENTION

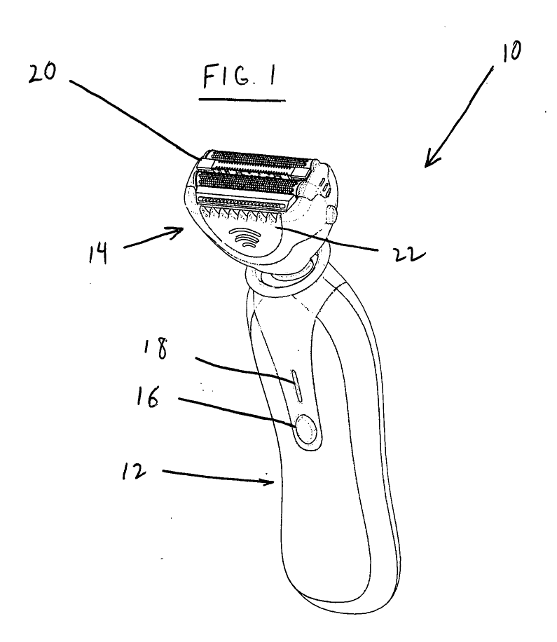

Referring to FIG. 1, the preferred embodiment of the present invention for a shaving device 10 is shown. The shaving device 10 contains a housing 12 and a shaver head 14. The housing 12 preferably has a switch 16 to turn the power on or off and an indication light 18 to indicate whether the power is on or off. The head 14 can have one or more shaving foils 19 and one or more trimmers 20 to trim hair, as well as a trimming guide 22 to control the length at which the hair is trimmed.

FIG. 2A shows a charger 24 that can be used to charge the battery (not shown) of the shaving device. FIG. 2B shows the shaving device 10 in the position as it is preferably placed in order to charge the device 10. In an alternate embodiment of the present invention, the shaving device 10 can have a cord to connect the shaver to an electrical outlet to provide power.

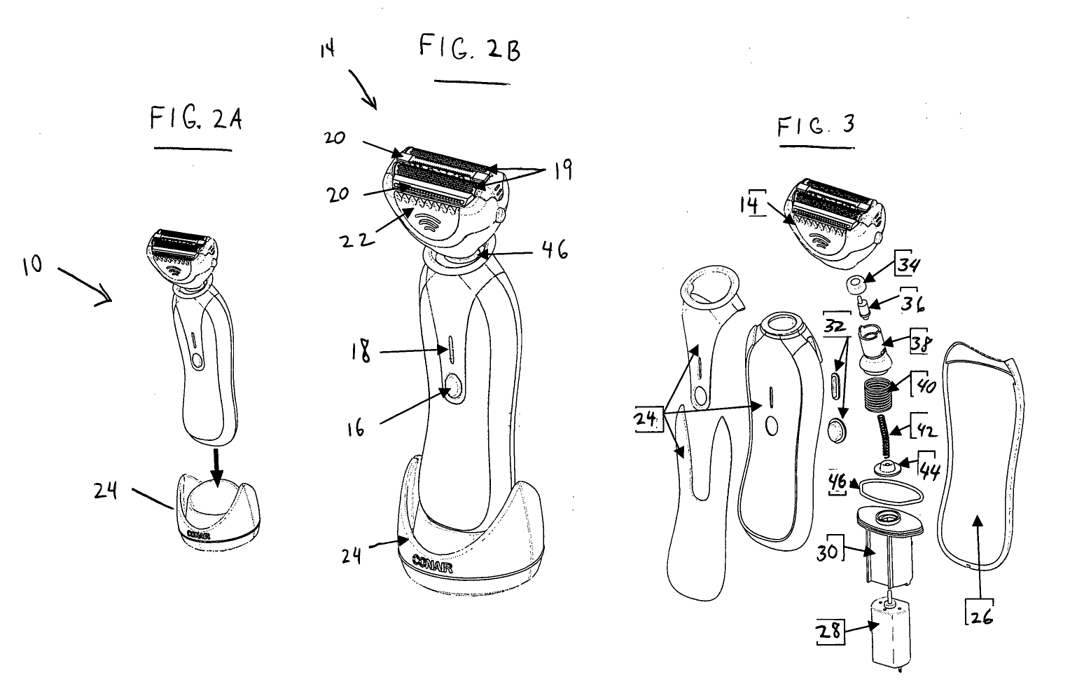

FIG. 3 is an exploded view of the preferred embodiment of the shaving device 10 showing the various components associated with the device 10. The housing 12 is preferably comprised of a front housing 24 and a rear housing 26. Within the housing 12 is preferably located a motor 28, a motor housing 30 to hold the motor 28, a light and switch cover 32, a bearing 34, an eccentric cam 36, a swivel neck 38, a positioning spring 40, a motion transfer spring 42, a water-resistant cap 44 and a water-resistant O-ring 46, as is further explained below.

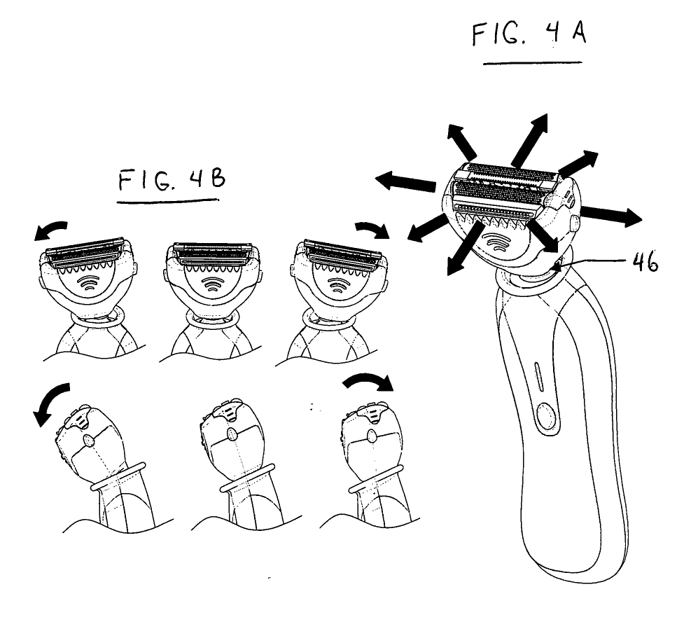

FIG. 4A shows the swivel ball joint 46 that is preferably located between the shaver head 14 and the housing 12. This swivel ball joint 46 enables the head 14 of the shaver 10 to move in any direction from a longitudinal axis through the shaving device 10. This enables the head 14 and accompanying trimmers 20 to move to the contour of the body part being shaved. FIG. 4B shows examples of how the head can move to the sides or to the front and back of the housing 12.

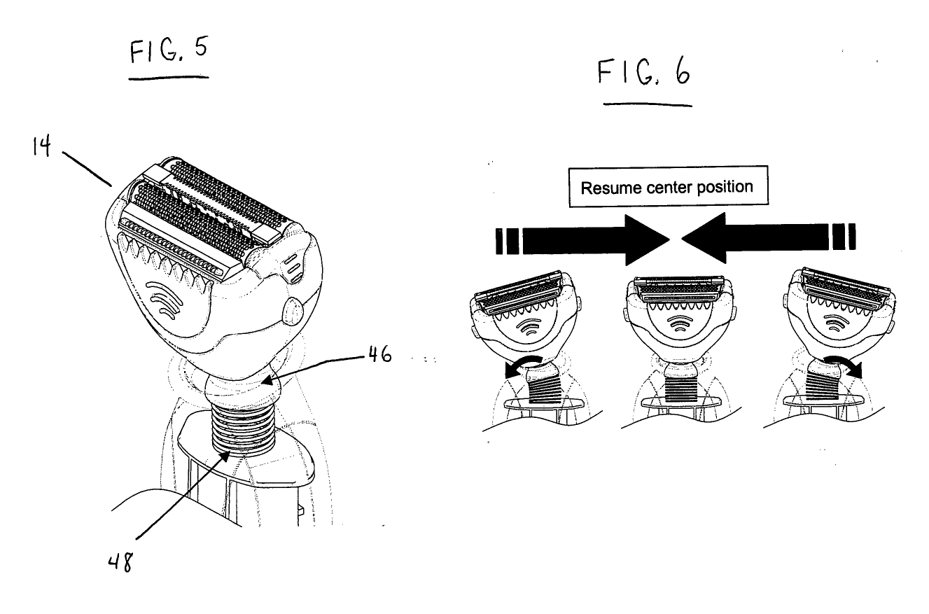

FIG. 5 shows the positioning spring 40, which is connected to the ball joint 46 and the housing 12. The positioning spring 40 is biased toward the center axis of the shaver 10. It provides a swivel action that causes the shaver head 14 to return back to its center position after adjustment of the head's angle. FIG. 6 illustrates this return to center position after initially being flexed in one direction or the other.

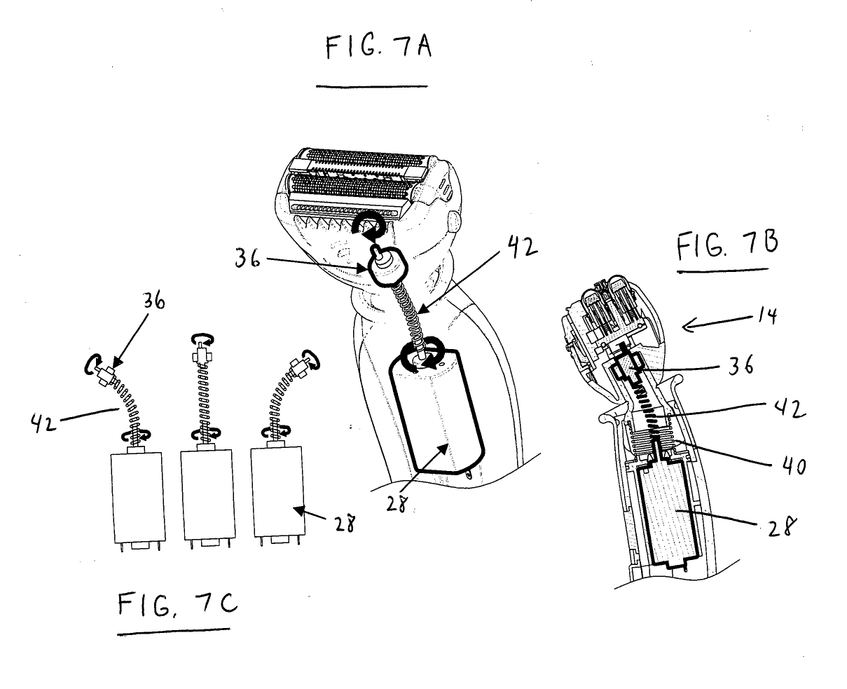

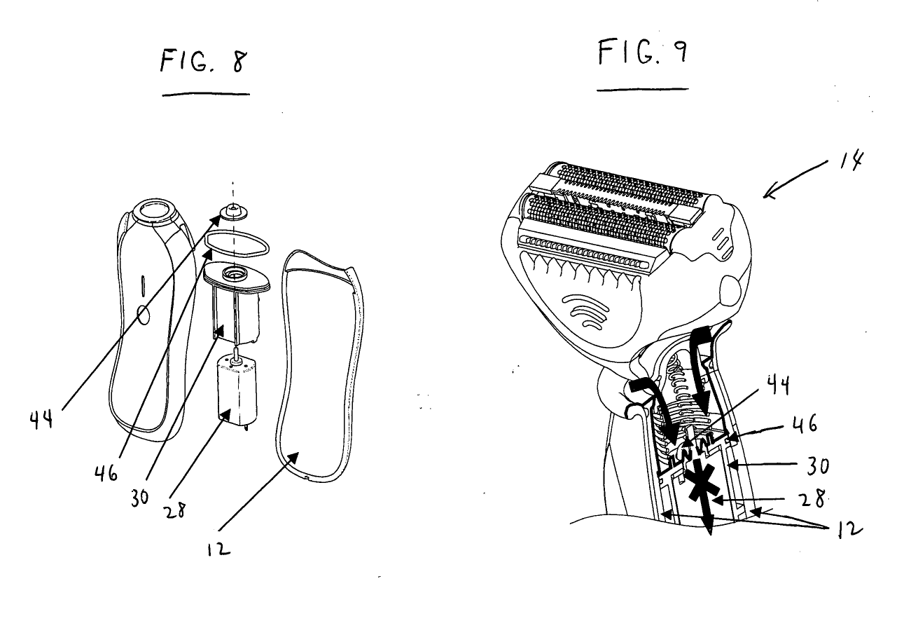

FIG. 7 shows a motion transfer mechanism that transfers the motor action to the upper shaving mechanism at any angle or direction that the shaver head 14 may be in at any time. This is accomplished through the use of a motion transfer spring 42 that connects the motor 28 to the eccentric cam 36. As the shaver head 14 changes angles to match the contour of the user's body, the motion transfer spring 42 flexes to follow the angles of the shaver head 14. This transfers the motion of the motor 28 to the eccentric cam 36, which helps to control the motion of the trimmers 20.

In order to prevent water from entering into the electrical parts, a water-resistant cap 44 and a water-resistant O-ring 46 can be utilized. As illustrated in FIGS. 8 and 9, the water-resistant cap 44 is preferably located above the motor mount 30 to prevent water from seeping into the motor 28. The water-resistant O-ring 46 is preferably placed around the top circumference of the motor mount 30 to prevent water from seeping past the outside of the motor mount 30 to the bottom of the shaving device 10. Other methods of preventing water from entering the electrical parts can also be utilized.

In one embodiment of the present invention, the head 14 of the shaving device 10 can be made to be interchangeable for different types of grooming purpose. For example, one head can be used for trimming, an alternate head could be used for epilator purposes, etc.

While a preferred embodiment of the invention has been herein disclosed and described, it is understood that various modifications can be made without departing from the scope of the invention.

What is claimed is:

1. A shaving device comprising:
a housing;
a motor within said housing;
a shaving head having one or more trimmers; and
a ball joint between said housing and said shaving head to enable said shaving head to move along the contours of a user's body.

2. A shaving device according to claim 1, further comprising
a motion transfer spring to enable the movement of said motor to be transferred to said shaving head.

3. A shaving device according to claim 1, further comprising
a positioning spring to enable said shaving head to return toward a central axis of said shaving device.

4. A shaving device according to claim 1, further comprising
a water resistant cap to prevent water from entering said housing.

5. A shaving device according to claim 1, further comprising
a water resistant O-ring to prevent water from entering said housing.

6. A shaving device according to claim 1, wherein
said shaving head further comprises a trimming guide to control the length of hair being cut.
